(19) United States
(12) Patent Application Publication
(10) Pub. No.: US 2018/0016812 A1
(43) Pub. Date: Jan. 18, 2018

(54) COMBINATION LOCK

(71) Applicant: The Master Lock Company LLC, Oak Creek, WI (US)

(72) Inventor: Eric Douglas Sanford, Milwaukee, WI (US)

(73) Assignee: The Master Lock Company LLC, Oak Creek, WI (US)

(21) Appl. No.: 15/649,979

(22) Filed: Jul. 14, 2017

Related U.S. Application Data
(60) Provisional application No. 62/362,143, filed on Jul. 14, 2016.

(51) Int. Cl. E05B 37/00

(52) U.S. Cl. CPC E05B 37/0024; E05B 37/0034; E05B 37/0068

(57) ABSTRACT

A padlock includes a lock body, a locking element movable between a locked position and an unlocked position, a latch, a user manipulable lock interface, an actuator mechanism, and a counter member. When the lock interface is operated to a sequence of N correct code entry conditions, the latch is moved from an initial locked position to an unlocked position. When the lock interface is operated to any one of the plurality of code entry conditions, the actuator mechanism engages the counter member and incrementally advances the counter member toward a stop position. When the lock interface is operated to a sequence of N code entry conditions in which at least one of the sequence of N code entry conditions is an incorrect code entry condition, the counter member is moved from the start position to the stop position before the latch can be advanced to the unlocked position.

### CROSS-REFERENCE TO RELATED APPLICATION

This application claims priority to and all benefit of U.S. Provisional Patent Application Ser. No. 62/362,143, filed on Jul. 14, 2016, for COMBINATION LOCK, the entire disclosure of which is fully incorporated herein by reference.

### BACKGROUND

Security devices, such as padlocks and other types of conventional locks, are used, for example, to prevent access to a room, building, enclosure, container, or piece of equipment. Exemplary padlocks include those opened by a key and those opened by manipulation of lock components in accordance with a unique combination. In a conventional padlock, a shackle is secured within a lock body by one or more internal locking members that are received in corresponding notches in the shackle to prevent axial withdrawal of the shackle from the lock body.

### SUMMARY

The present application describes locking arrangements for securing a lock, such as, for example, a padlock, in a locked condition against unauthorized attempts to unlock or open the lock. According to one exemplary aspect of the present application, a lock may include a latch or latching mechanism having a locking element moveable between locked and unlocked positions, a latch or latching mechanism that is incrementally advanced from an initial locked position to an unlocked position with each correct code entry in a sequence of code entries entered by a lock interface, and a counter member that limits the number of code entries to the number in a correct code sequence, such that entry of a single code entry by the lock interface prevents movement of the latch to the unlocked position.

Accordingly, in an exemplary embodiment, a padlock includes a lock body, a locking element movable between a locked position and an unlocked position, a latch, a user manipulable lock interface, an actuator mechanism, and a counter member. The latch is movable between an initial locked position, in which the latch blocks movement of the locking element from the locked position to the unlocked position, and an unlocked position, in which the latch permits movement of the locking element from the first position to the second position. The lock interface is selectively operable to a plurality of code entry conditions. The actuator mechanism is operable by user manipulation of the lock interface to any one of the plurality of code entry conditions. When the lock interface is operated to a correct one of the plurality of code entry conditions, the actuator mechanism engages the latch and incrementally advances the latch toward the unlocked position, such that when the lock interface is operated to a sequence of N correct code entry conditions, the latch is moved from the initial locked position to the unlocked position. The counter member is movable between a start position and a stop position in which the counter member prevents further operation of the actuator mechanism. When the lock interface is operated to any one of the plurality of code entry conditions, the actuator mechanism engages the counter member and incrementally advances the counter member toward the stop position. When the lock interface is operated to a sequence of N code entry conditions in which at least one of the sequence of N code entry conditions is an incorrect code entry condition, the counter member is moved from the start position to the stop position before the latch can be advanced to the unlocked position.

### BRIEF DESCRIPTION OF THE DRAWINGS

Further features and advantages of the invention will become apparent from the following detailed description made with reference to the accompanying drawings, wherein:

FIG. 1A is a front cross-sectional schematic view of an exemplary padlock shown in a locked condition;

FIG. 1B is a front cross-sectional schematic view of the padlock of FIG. 1A, shown in an unlocked condition;

FIG. 1C is a front cross-sectional schematic view of the padlock of FIG. 1A shown in an opened condition;

FIG. 2A is a front view of an exemplary padlock, in accordance with an exemplary embodiment of the present invention;

FIG. 2B is a right side view of the padlock of FIG. 2A, the left side view being a mirror image thereof;

FIG. 2C is a rear view of the padlock of FIG. 2A;

FIG. 3A is an exploded perspective view of the padlock of FIG. 2A;

FIG. 3B is a rear cross-sectional view of the padlock of FIG. 2A;

FIG. 4 is an exploded perspective view of the actuator mechanism of the padlock of FIG. 2A;

FIG. 5A is a side cross-sectional view of the lock body and button arrangement of the padlock of FIG. 2A;

FIG. 5B is a front view of the lock body of the padlock of FIG. 2A;

FIG. 6 is a front view of the actuator mechanism of the padlock of FIG. 2A, shown in a centered condition;

FIG. 7 is a front view of the actuator mechanism of the padlock of FIG. 2A, shown in an actuated condition;

FIG. 8 is a perspective view of the actuator mechanism of the padlock of FIG. 2A;

FIG. 9 is a front view of the actuator members and latch wheel of the padlock of FIG. 2A;

FIG. 10 is an exploded perspective view of the latch and counter wheel arrangements of the padlock of FIG. 2A;

FIG. 11A is an perspective view of the counter wheel of the padlock of FIG. 2A;

FIG. 11B is a perspective view of the front insert of the padlock of FIG. 2A;

FIG. 12 is a front view of the code wheel member of the padlock of FIG. 2A;

FIG. 12A is a front view of the alignment wheel member of the padlock of FIG. 2A;

FIG. 13 is a front view of the counter wheel of the padlock of FIG. 2A;

FIG. 14 is a perspective view of the detent wheel member of the padlock of FIG. 2A;

FIG. 15 is a front view of the latch wheel, detent member, and actuator member of the padlock of FIG. 2A;

FIG. 16 is a perspective view of the latch wheel of the padlock of FIG. 2A;

FIG. 17 is a side view of the latch wheel and detent member of the padlock of FIG. 2A;

FIG. 18 is a perspective view of the detent wheel member of the padlock of FIG. 2A;

FIG. 19A is a front view of the latch wheel, counter wheel, detent member, and blocker of the padlock of FIG. 2A, shown in the initial locked or reset condition;

FIG. 19B is a front view of the latch wheel, counter wheel, detent member, and blocker of the padlock of FIG. 2A, shown in an incorrect code entry condition;

FIG. 19C is a front view of the latch wheel, counter wheel, detent member, and blocker of the padlock of FIG. 2A, shown in the unlocked condition;

FIG. 20 is a perspective view of a code wheel member according to another exemplary embodiment;

FIG. 21A is a perspective view of the reset mechanism of the padlock of FIG. 2A;

FIG. 21B is an exploded perspective view of the reset mechanism of the padlock of FIG. 2A;

FIG. 22 is a perspective view of the reset mechanism and shackle of the padlock of FIG. 2A;

FIG. 23A is a front view of the reset mechanism of the padlock of FIG. 2A, shown in the non-actuated condition;

FIG. 23B is a front view of the reset mechanism of the padlock of FIG. 2A, shown in the partially actuated condition;

FIG. 23C is a front view of the reset mechanism of the padlock of FIG. 2A, shown in the actuated, reset condition;

FIG. 24 is a rear view of the cam actuating arm and cam of the padlock of FIG. 2A;

FIG. 25A is a perspective view of the latch wheel, code wheel, cam actuating arm and cam of the padlock of FIG. 2A, shown in the unlocked condition;

FIG. 25B is a perspective view of the latch wheel, code wheel, cam actuating arm and cam of the padlock of FIG. 2A, shown in the reset condition;

FIG. 26 is an exploded perspective view of the override mechanism of the padlock of FIG. 2A;

FIG. 27A is a rear view of the latch wheel, counter wheel, and override mechanism of the padlock of FIG. 2A, shown in the locked condition;

FIG. 27B is a rear view of the latch wheel, counter wheel, and override mechanism of the padlock of FIG. 2A, shown in the unlocked condition;

FIG. 28A is a front view of another exemplary padlock, in accordance with an exemplary embodiment of the present invention;

FIG. 28B is a side view of the padlock of FIG. 28A;

FIG. 28C is a rear view of the padlock of FIG. 28A;

FIG. 28D is a top view of the padlock of FIG. 28A;

FIG. 28E is a bottom view of the padlock of FIG. 28A;

FIG. 28F is a front perspective view of the padlock of FIG. 28A;

FIG. 28G is a rear perspective view of the padlock of FIG. 28A;

FIG. 29A is an exploded perspective view of the padlock of FIG. 28A;

FIG. 29B is a rear cross-sectional view of the padlock of FIG. 28A;

FIG. 30 is an exploded perspective view of the actuator mechanism of the padlock of FIG. 28A;

FIG. 31A is a side cross-sectional view of the lock body and button arrangement of the padlock of FIG. 28A;

FIG. 31B is a front view of the lock body of the padlock of FIG. 28A;

FIG. 32 is a perspective view of the actuator mechanism of the padlock of FIG. 28A;

FIG. 33 is a front view of the actuator members and latch wheel of the padlock of FIG. 28A;

FIG. 34 is an exploded perspective view of the latch and counter wheel arrangements of the padlock of FIG. 28A;

FIG. 35A is an perspective view of the counter wheel of the padlock of FIG. 28A;

FIG. 35B is a perspective view of the front insert of the padlock of FIG. 28A;

FIG. 36 is a front view of the code wheel member of the padlock of FIG. 28A;

FIG. 37 is a front view of the counter wheel of the padlock of FIG. 28A;

FIG. 38 is a front view of the latch wheel, detent member, and actuator member of the padlock of FIG. 28A;

FIG. 39A is a front view of the latch wheel, counter wheel, detent member, and blocker of the padlock of FIG. 28A, shown in the initial locked or reset condition;

FIG. 39B is a front view of the latch wheel, counter wheel, detent member, and blocker of the padlock of FIG. 28A, shown in an incorrect code entry condition;

FIG. 39C is a front view of the latch wheel, counter wheel, detent member, and blocker of the padlock of FIG. 28A, shown in the unlocked condition;

FIG. 40 is a lower perspective view of the blocker of the padlock of FIG. 28;

FIG. 41 is a perspective view of the reset mechanism and shackle of the padlock of FIG. 28A;

FIG. 42A is a front view of the reset mechanism of the padlock of FIG. 28A, shown in the non-actuated condition;

FIG. 42B is a front view of the reset mechanism of the padlock of FIG. 28A, shown in the partially actuated condition;

FIG. 42C is a front view of the reset mechanism of the padlock of FIG. 28A, shown in the actuated, reset condition;

FIG. 43 is a perspective view of the latch wheel, code wheel, cam actuating arm and cam of the padlock of FIG. 28A;

FIG. 44A is a rear view of the latch wheel, counter wheel, and override mechanism of the padlock of FIG. 28A, shown in the locked condition; and

FIG. 44B is a rear view of the latch wheel, counter wheel, and override mechanism of the padlock of FIG. 28A, shown in the unlocked condition.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meaning.

Also, while the exemplary embodiments described in the specification and illustrated in the drawings relate to a combination padlock having a button slideable in one of four directions (i.e., up, down, left, right) for entry of a direction-based combination code, it should be understood that many of the inventive features described herein may be applied to other types of padlocks, including, for example, push button, permutation dial, and multiple dial padlocks, padlocks having directional buttons movable in more and/or different directions, and different types of locking devices, including, for example, safes, lock boxes, cable locks, and locking bolts.

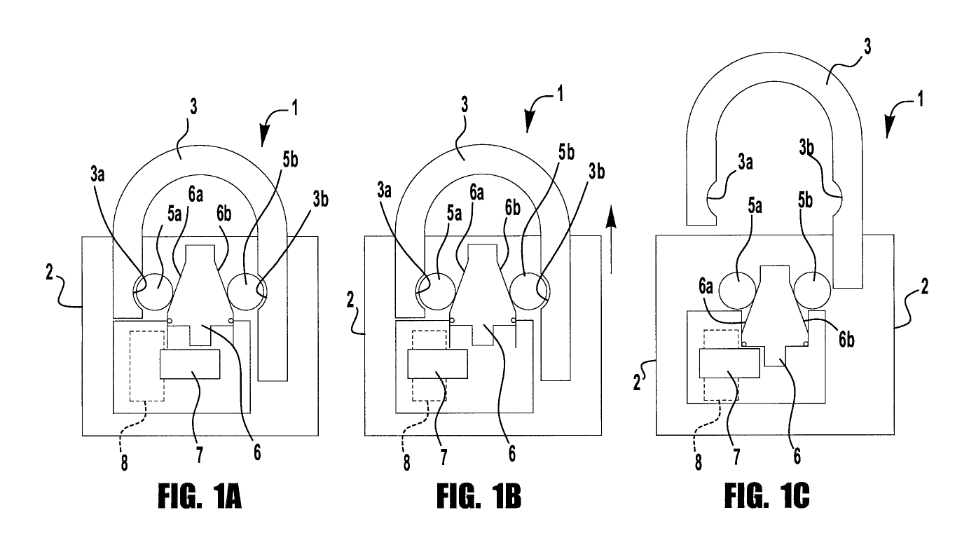

The present application contemplates, in part, a latching mechanism for a lock (e.g., a padlock) that provides for secure locking of the lock, to prevent picking, jamming, shimming or other such defeating of the lock latching mechanism by directly or indirectly moving one or more locking members (e.g., locking balls or rollers) out of locking engagement with a locking element (e.g., a padlock shackle). In one such exemplary padlock 1, as schematically shown in FIGS. 1A, 1B, and 1C, a blocker 6 disposed within the lock body 2 forces locking members 5a, 5b into locking engagement with notches 3a, 3b in the padlock shackle 3. In the locked condition, shown in FIG. 1A, a latch member 7 adjacent to an end portion 6′ of the blocker 6 prevents movement of the blocker 6 to a shackle releasing position that permits disengagement of the locking members 5a, 5b from the shackle notches 3a, 3b. In the unlocked condition, shown in FIG. 1B, the latch member 7 is moved or is made movable by an actuating mechanism (shown schematically at 8) to provide clearance for the blocker end portion 6′ to permit movement of the blocker 6 to the shackle releasing position (shown in FIG. 1C).

Many different types of latch members may be utilized to selectively obstruct or permit movement of the blocker, including, for example, sliding, pivoting, and/or rotating latch components. In one embodiment, a latch member includes a rotatable wheel having a cutout portion that aligns with the blocker end portion in an unlocked condition to permit movement of the blocker to the shackle releasing position.

While user rotatable dials or knobs are often used as a lock interface for a combination lock (e.g., a combination padlock), a button-based combination lock interface may provide alternative unlocking operations that may, in some embodiments, offer quicker operation, easier manipulation, or other such advantages. Examples include multiple pushbutton lock interfaces, or a sliding button lock interface.

Many different types of button-based or other such actuating mechanisms may be utilized to selectively rotate a rotatable wheel latch member in a padlock for alignment of the wheel recess/cutout with the blocker. In one embodiment, an actuating mechanism includes a plurality of wheel engaging actuators each operable to incrementally rotate the wheel when the correct one (in accordance with a predetermined combination code) of the plurality of actuators is actuated. When the plurality of actuators is actuated in the correct sequence, the resulting rotation of the wheel (i.e., the sum of the incremental rotations) aligns the wheel recess with the blocker to permit sliding, unlocking movement of the blocker. When an incorrect actuator is actuated (e.g., actuated out of sequence), the wheel is not incrementally rotated by that actuation. According to an aspect of the present application, the actuating mechanism may be configured to limit a combination code entry to a predetermined number of actuations, such that when one of the actuations is of an incorrect actuator, therefore failing to rotationally advance the wheel, the wheel is prevented from being rotated into the unlocking orientation after the permissible number of actuations.

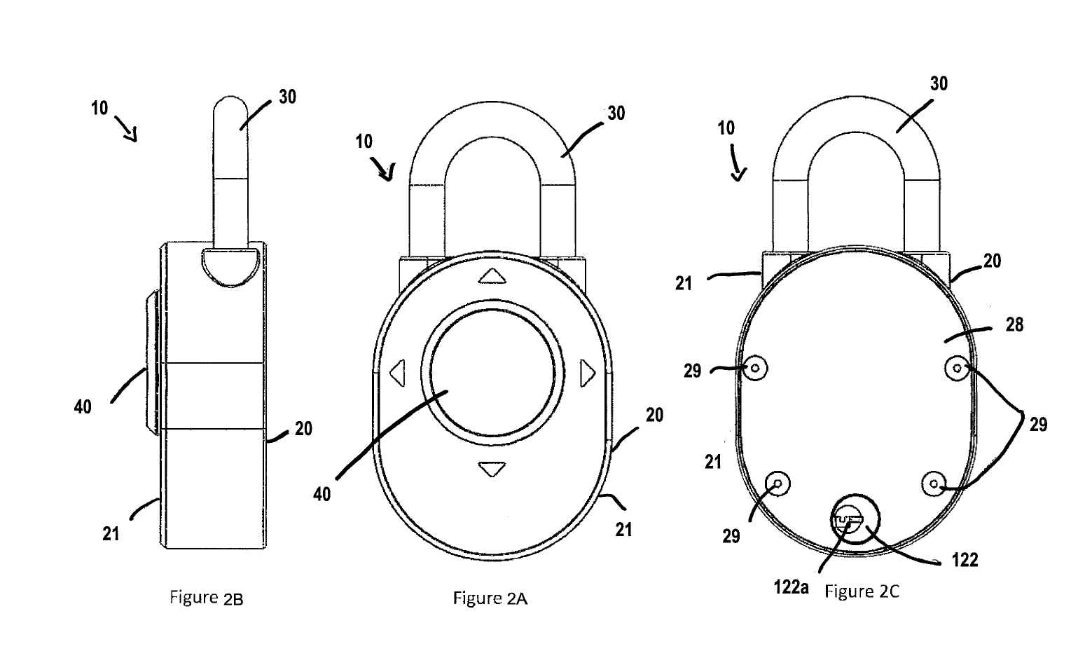

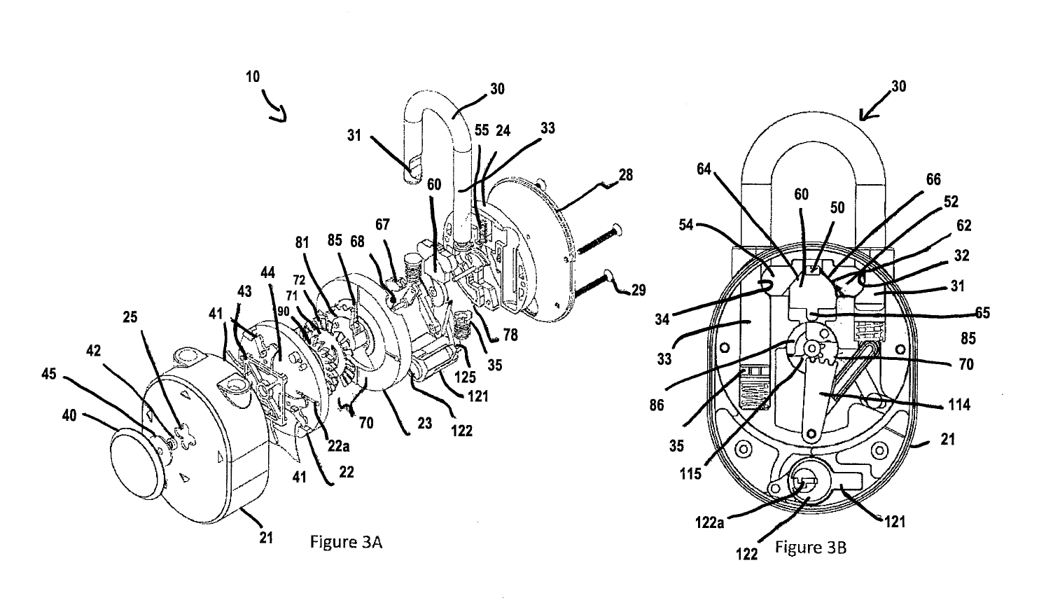

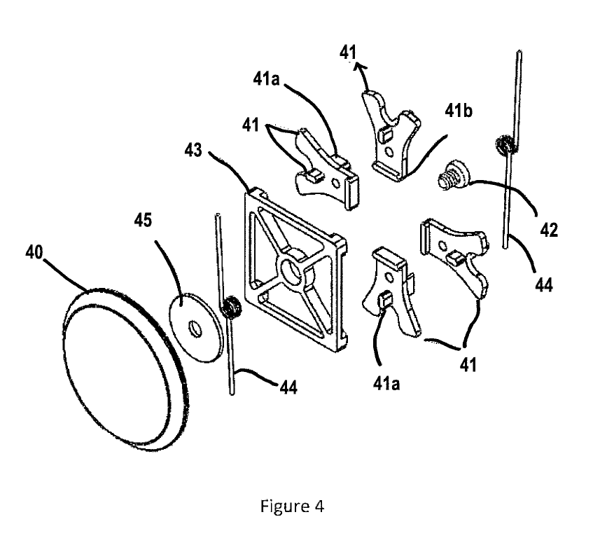

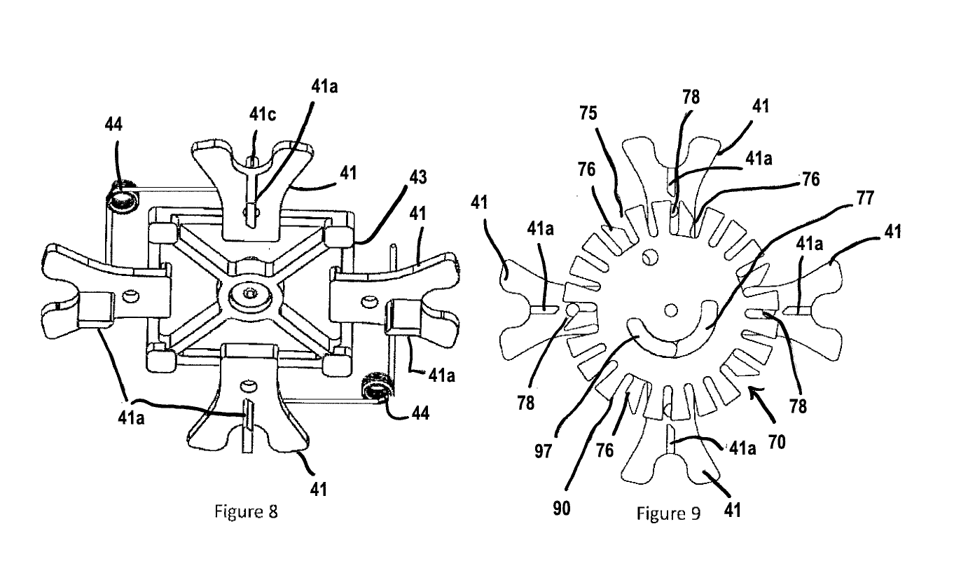

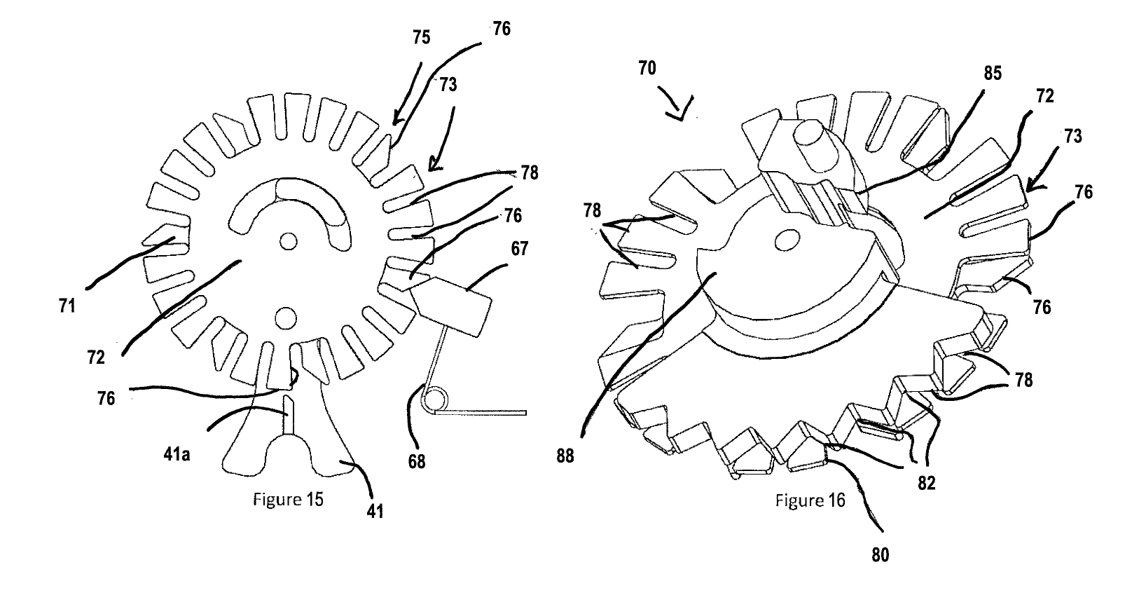

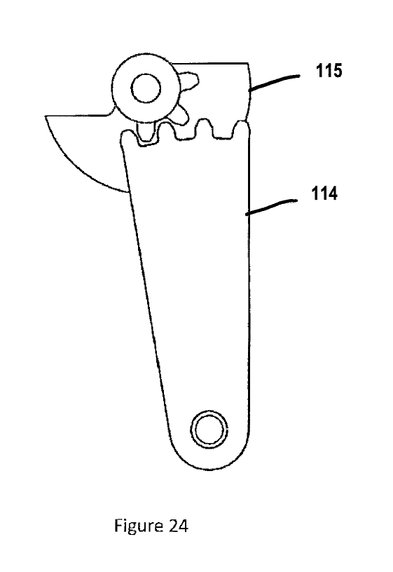

FIGS. 2A-27B illustrate an exemplary padlock 10 having a lock body 20 and a shackle 30. The exemplary lock body 20 includes a back plate 28 secured to a main housing 21 by fasteners 29 to define an internal cavity of the lock. As shown in the exploded view of FIG. 3A, a front insert 22, a middle insert 23, and a rear insert 24 are fixed within the main housing 21 to support the internal locking components, as described in greater below.

The shackle 30 is assembled with the lock body 20, and received between the middle and rear inserts 23, 24, for movement between a shackle engaged or closed condition, in which both legs 31, 33 of the shackle 30 are received within the lock body 20, and a shackle disengaged or open condition, in which the short shackle leg 31 is disengaged or withdrawn from the lock body, to permit removal of the padlock 10 from a hasp, locker latch, or other external structure. As shown in FIGS. 3B, the shackle 30 is secured in a locked condition by an internal locking mechanism 50 including an axially slidable blocker 60 (disposed between the middle and rear inserts 23, 24) with side blocking surfaces that force locking members 52, 54 laterally outward into notches 32, 34 in the shackle legs 31, 33 to secure the shackle 30 in the engaged condition. The blocker 60 includes an extension or post 65 that confronts or abuts against a blocking portion 85 of a latch wheel 70 when the latching mechanism 50 is in the locked condition (and against an arcuate rail shaped blocking portion 97 of a counter wheel 90, as discussed in greater detail below), thereby preventing axial movement of the blocker 60, thus securing the shackle 30 in the engaged condition. The latch wheel 70 is disposed between the front insert 22 and the middle insert 23 with the blocking portion 85 extending through a hole in the middle insert for alignment with the blocker 60. The latch wheel 70 is rotatable about a central wheel axis defined by a central pin 27 extending through a center hole in the latch wheel 70 and supported by the front insert 22 and the back plate 28.

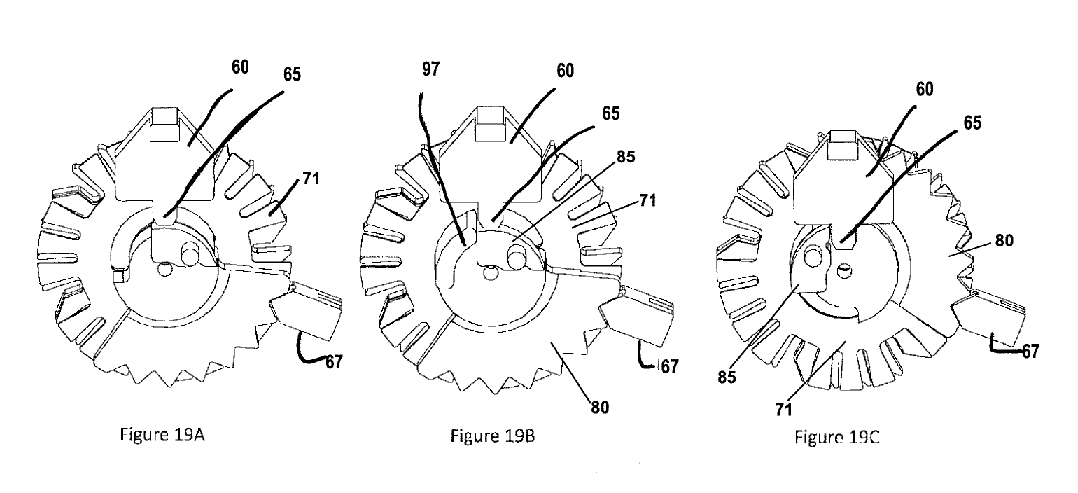

When the exemplary latch wheel 70 is rotated to an unlocked orientation, a recess or cutout 86 in the latch wheel 70 aligns with the blocker post 65 to permit axial movement of the blocker 60 into the recess 86 (FIG. 19C). In this unlocked condition, when the shackle 30 (FIG. 3B) is axially pulled in an opening or withdrawing direction, a laterally inward force is directed from the shackle notches 32, 34 through the locking members 52, 54 to tapered camming surfaces 62, 64 of the blocker 60. These laterally inward forces against the tapered camming surfaces 62, 64 move the blocker 60 axially downward against a nested spring 55, such that the post 65 is received in the recess 86. In this axially downward position, laterally inward forces on the locking members 52, 54 (from pulling on the shackle 30) push the locking members laterally inward against a necked down portion 66 of the blocker 60, and out of engagement with the shackle notches 32, 34, thereby allowing the shackle 30 to be withdrawn to the disengaged or open position. The long shackle leg 33 may be provided with a retaining clip 35 or other structure to prevent complete withdrawal of the shackle 30 from the lock body 20.

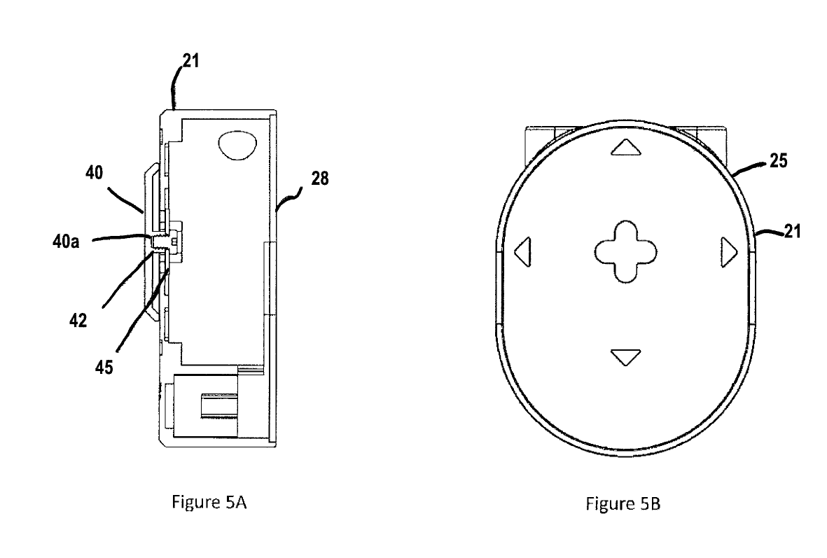

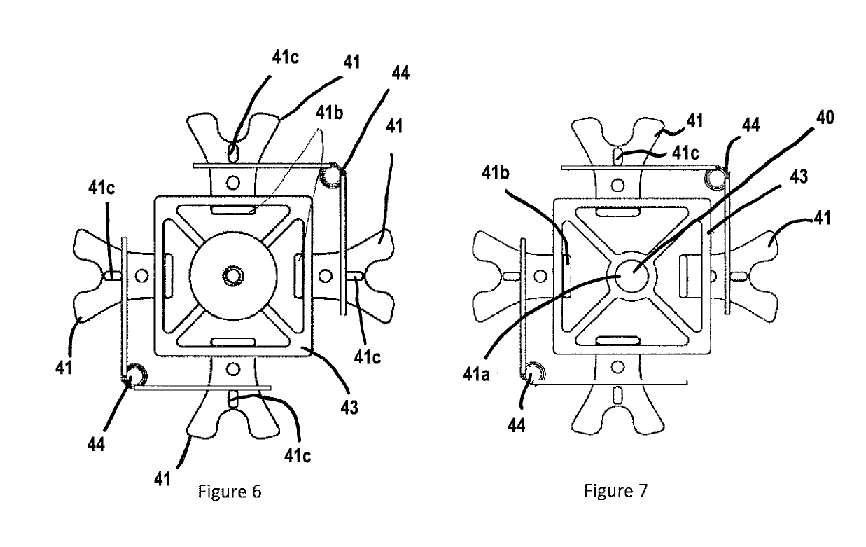

While many different mechanisms may be utilized to effect rotation of the latch wheel 70, in the illustrated embodiment, a directionally slideable button 40 is secured to the lock body 20 (e.g., by a button fastener 42 and washer 45) and is slideable to move a selected one of a plurality of actuator members 41 (disposed between the main housing 21 and the front insert 22) radially inward against a contoured code portion 75 of the latch wheel 70 (see FIG. 9) to incrementally rotate the latch wheel from an initial unlocked orientation (FIG. 19A) toward the unlocked orientation (FIG. 19C). While many different structures may be utilized, in the illustrated embodiment, the button 40 includes a boss portion 40a, which receives the fastener 42, that extends through a guide slot 25 (FIG. 5B) in the main housing 21 for attachment with an actuating frame 43 disposed between the main housing 21 and the front insert 22. When the button 40 is moved in one of the directions (e.g., up, down, left, right) permitted by the guide slot 25, as shown in FIG. 7, the actuating frame 43 is moved to pull one of the actuator members 41 (e.g., by engagement with a radially inner flange portion 41b) radially inward while leaving the other actuator members 41 in the non-actuated, radially outward position. Spring members 44 bias the actuator members 41 (e.g., against rib projections 41c, as shown in FIGS. 6 and 7) toward the radially outward positions, and also function to return the button 40 to a central, non-actuated position when released by the user.

In the exemplary embodiment, each actuator member 41 includes an actuating portion 41a (e.g., a projection) that extends through a slot 22a in the front insert 22 and aligns with the latch wheel code portion 75. The code portion 75 includes ramped outer teeth 76 that are arranged such that in each incremental locked orientation between an initial locked orientation and the unlocked orientation, only one of the plurality of actuator members 41 is aligned with a ramped outer tooth 76, such that only actuation of the aligned actuator member will incrementally advance the latch wheel 70 toward the unlocked orientation by engagement of the ramped actuating portion 41a of that actuator member 41 with the ramped tooth 76. Actuation of any of the other, non-aligned actuator members 41 cause these actuator members to be received in non-engaging gaps or slots 78 in the latch wheel 70, thereby permitting sliding movement of the button 40 and selected actuator member 41, but preventing incremental rotation of the latch wheel 70.

The latch wheel 70 may be configured to incrementally rotate from an initial locked orientation to an unlocked orientation in accordance with an unlocking sequence comprising N code entries, including, for example, a six-entry sequence (i.e., N=6), with six incremental latch wheel rotations between the initial locked orientation and the unlocked orientation. In other embodiments, other sequence lengths may be utilized (e.g., between three and twelve entries). In such an embodiment, the blocking portion 85 of the latch wheel 70 is at least partially aligned with the blocker post 65 in each of the N incremental locking positions, with the blocker post 65 being separated from or spaced apart from the blocking portion 85, or aligned with the latch wheel recess 86, in the unlocking orientation.

According to another aspect of the present application, the latching mechanism may be configured to limit operation of the actuating mechanism to a number of entries corresponding to the predetermined length of the unlocking sequence (i.e., N entries, as discussed above), such that if any incorrect entries are effected, the latch wheel will fail to reach the unlocked orientation once this entry limit has been reached, with the code entry limiting arrangement preventing further code entry. In other embodiments, other arrangement may be used to prevent attainment of an unlocked orientated when an incorrect entry has been effected. For example (not shown), a latching mechanism may be configured to partially offset (e.g., axially or rotationally) the latch wheel recess from the blocker post when an incorrect entry is effected, such that any subsequent incremental rotation of the latch wheel maintain an at least partial offset condition of the latch wheel recess to prevent unlocking.

While many different mechanisms may be utilized to provide this code entry limiting arrangement, in the illustrated embodiment, the latching mechanism may be provided with a range limited counter wheel 90 that is incrementally rotated by actuation of any one of the actuator members 41, until the code entry limit has been reached, at which point further rotation of the counter wheel 90 and further advancement of the latch wheel 70 is effectively blocked. In the illustrated embodiment, the counter wheel 90 is disposed between the front and middle inserts 22, 23 and stacked with the latch wheel 70, and is rotatable about the central pin 27 which extends through a central hole in the counter wheel 90. The counter wheel 90 includes an arcuate rail 97 that is received in an arcuate track 77 of the latch wheel 70 to allow for limited relative rotation of the counter wheel 90 with respect to the latch wheel 70. The arcuate rail 97 also aligns with the blocker when the counter wheel is in any of the incremental locked orientations, to further block movement of the blocker 60 when the shackle 30 is pulled. Contoured gear teeth 92 are arranged around the periphery of the counter wheel 90 for engagement by the actuator member actuating portions 41a when any of the actuator members 41 is operated by the button 40 to incrementally advance the counter wheel 90. A raised projection 26 on the front insert 22 is received in an arcuate track 93 in the counter wheel 90 (FIG. 11) to limit the rotation of the counter wheel 90. When a number of incorrect entries corresponding to the length of the code sequence has been entered (FIG. 19B), the projection 26 abuts an end surface of the arcuate track 93 to prevent further rotation of the counter wheel 90, and further operation of the actuator members 41 by the button 40.

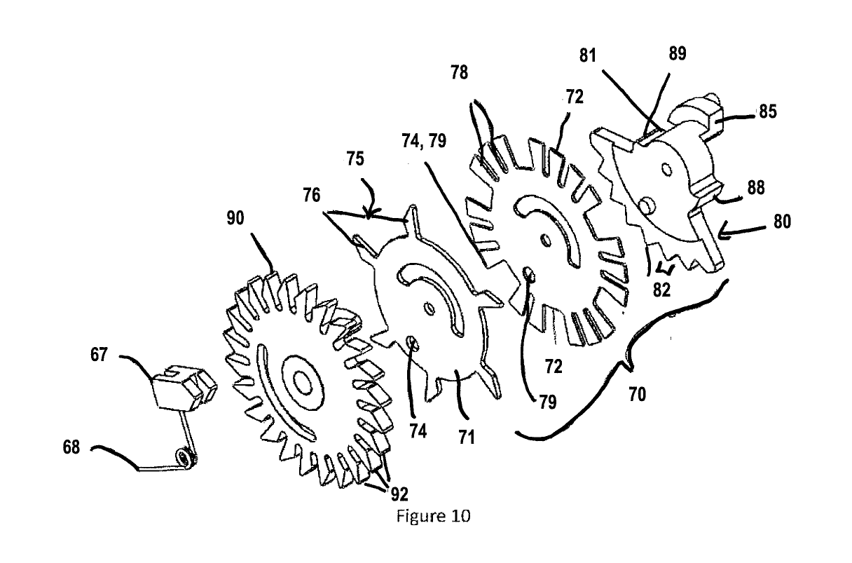

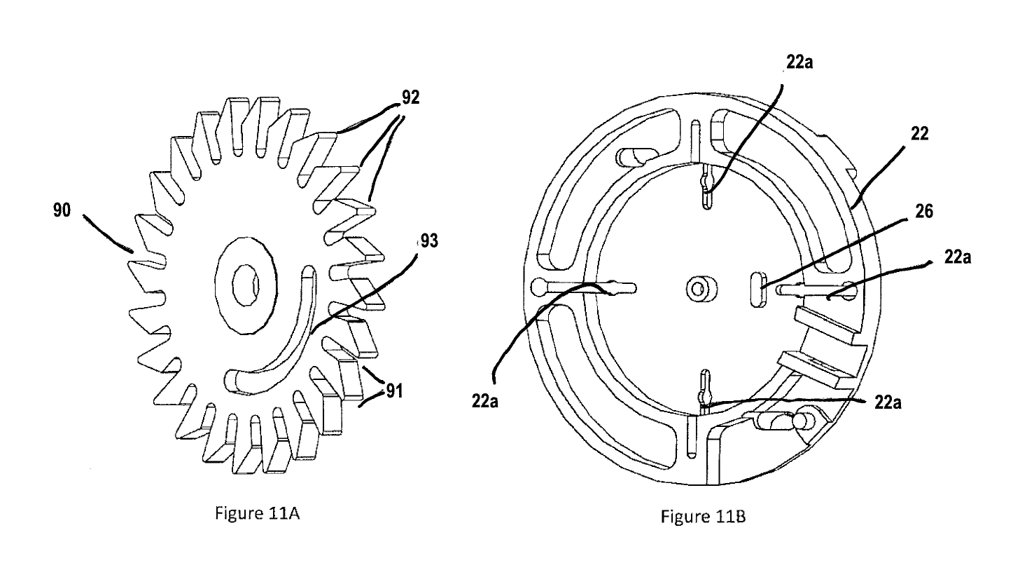

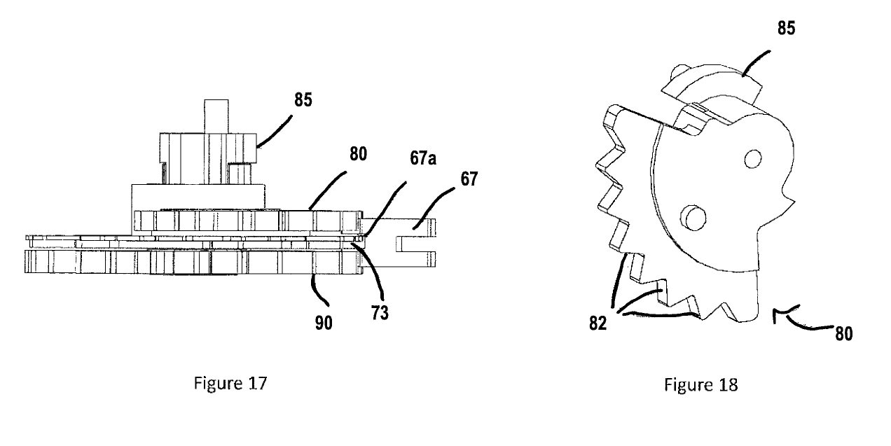

In the exemplary embodiment, control of the incremental rotation of the latch wheel 70 and counter wheel 90, as initiated by the selected actuator member 41, is facilitated by a detent member 67 (FIG. 10) that is spring-biased (e.g., by detent spring 68) against one of a series of ramped detent recesses 82 of a detent gear portion 80 on the latch wheel 70 and against a notch 91 between adjacent gear teeth 92 of the counter wheel 90. The detent member 67 may be shaped (e.g., with a clearance slot 67a, see FIG. 17) to engage the counter wheel 90 and the detent gear portion 80 of the latch wheel 70 without engaging the slotted alignment portion 73 of the latch wheel 70, which is disposed between the counter wheel 90 and the detent gear portion 80.

When the correct actuator member 41 is moved by user operation of the button 40, rotation of both the latch wheel 70 and the counter wheel 90 causes the detent member 67 to be radially moved out of engagement with both the detent recess 82 and the counter wheel notch 91, and the actuating portion 41a of the actuator member 41 partially incrementally advances both the latch wheel 70 and the counter wheel 90. In a partially incrementally advanced position, the detent member 67 is partially aligned with an adjacent detent recess 82 on the latch wheel 70, and is also partially aligned with an adjacent notch 91 in the counter wheel 90. When the button 40 is released, the detent member 67 is biased into engagement with both the adjacent detent recess 82 and the adjacent counter wheel notch 91, thereby further rotating the latch wheel 70 and the counter wheel 90 into a fully incremented position, and securing the latch wheel 70 and counter wheel 90 in this incremented position.

When an incorrect actuator member 41 is moved by incorrect user operation of the button 40, rotation of the counter wheel 90 causes the detent member 67 to be radially moved out of engagement with both the detent recess 82 and the counter wheel notch 91, and the actuating portion 41a of the actuator member 41 partially incrementally advances the counter wheel 90 (but not the latch wheel 70). In this partially incrementally advanced position, the detent member 67 is partially aligned with the adjacent notch 91 in the counter wheel 90. When the button 40 is released, the detent member 67 is biased into engagement with the same detent recess 82 and with an adjacent counter wheel notch 91, thereby further rotating the counter wheel 90 into the fully incrementally advanced position while maintaining the latch wheel 70 in the non-incremented position, and securing the latch wheel 70 and counter wheel 90 in these positions. While the detent member 67 is disengaged from the latch wheel 70, the actuating portion 41a of the actuated actuator member 41 engages an aligned one of a series of alignment slots 78 in an alignment portion 73 of the latch wheel 70, adjacent to or aligned with the code portion 75, to prevent free spinning of the latch wheel 70 while the latch wheel is disengaged from the detent member 67.

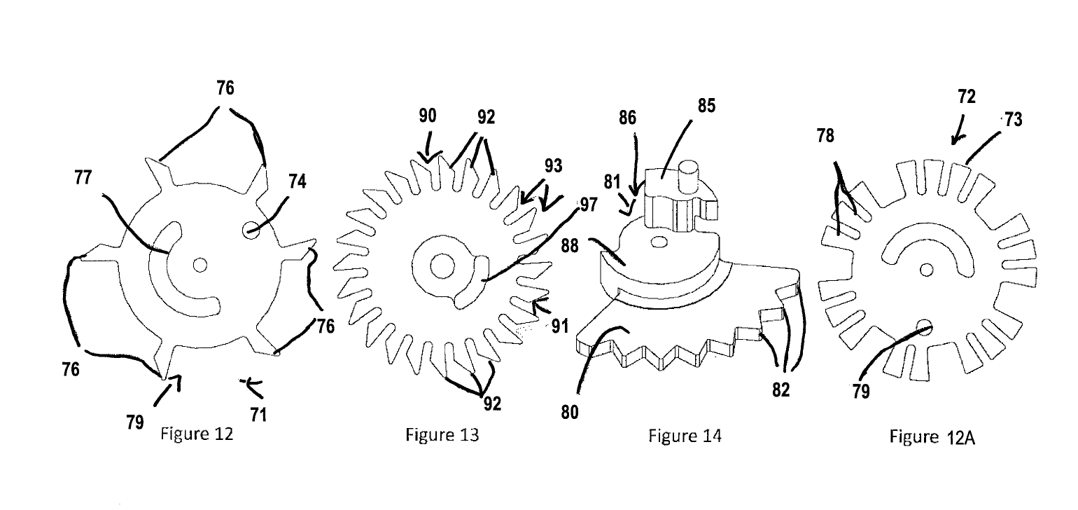

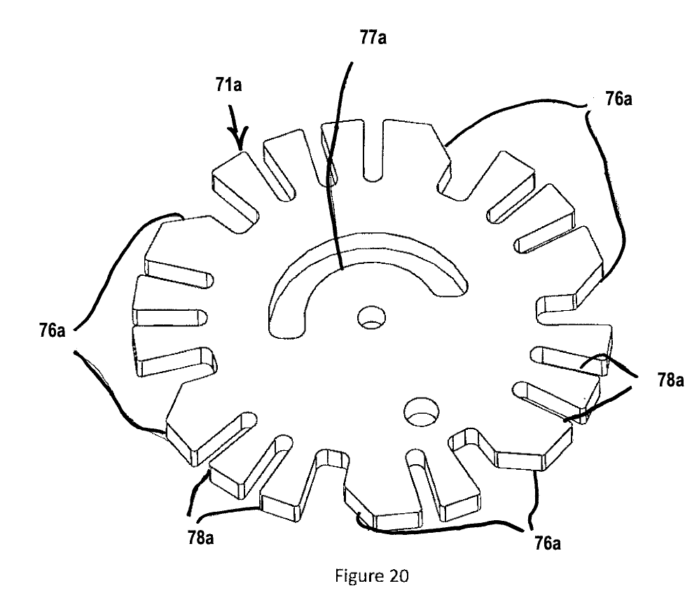

While the latch wheel may be formed as a unitary component, in other embodiments, the latch wheel may include multiple wheel members assembled together to provide the various latch wheel features, for example, for ease of manufacture or for flexibility in customization. In the illustrated embodiment, a code wheel member 71 (FIG. 12) defines the ramped outer code portion 75 (generally one tooth 76 per entry in the authorized code sequence) and the arcuate track 77. An alignment wheel member 72 (FIG. 16) defines the alignment portion 73 and alignment slots 78. (In another embodiment, as shown in FIG. 20, a code wheel member 71a may include the code portion teeth 76a, the arcuate track 77a, and the alignment slots 78a, thereby eliminating the alignment wheel member.) A detent wheel member 81 (FIG. 14) defines the detent gear portion 80 (with detent recesses 82), the camming portion 88 (described below), the blocking portion 85, and the latch wheel recess or cutout 86. The wheel members 71, 72, 81 are secured together for co-rotation, for example, by an alignment pin or post 89 (see FIG. 10) that extends from the detent wheel member 81 and is received through holes 74, 79 in the code wheel 71 and the alignment wheel 72.

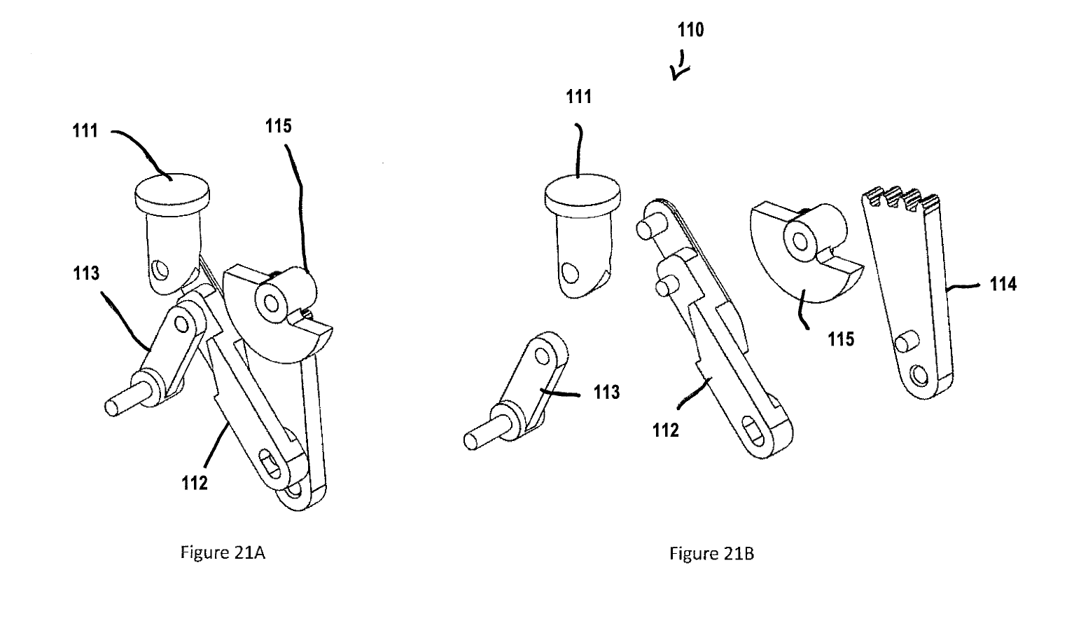

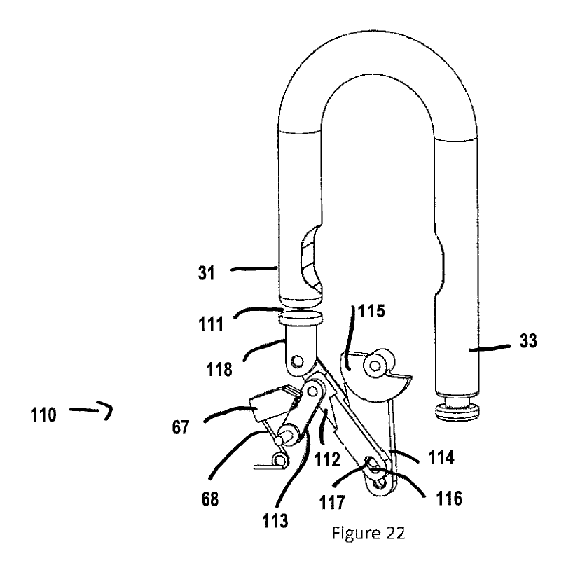

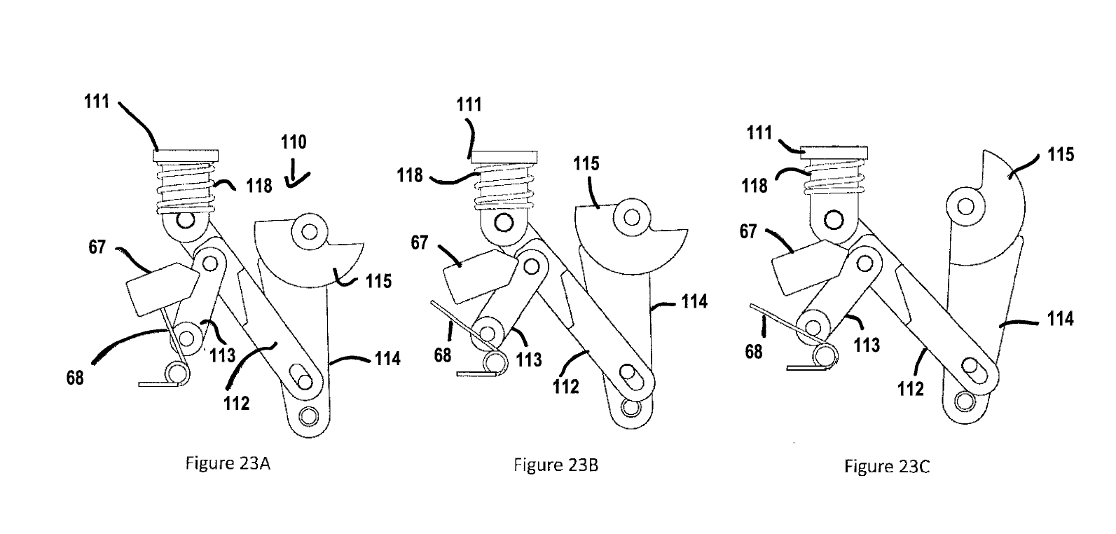

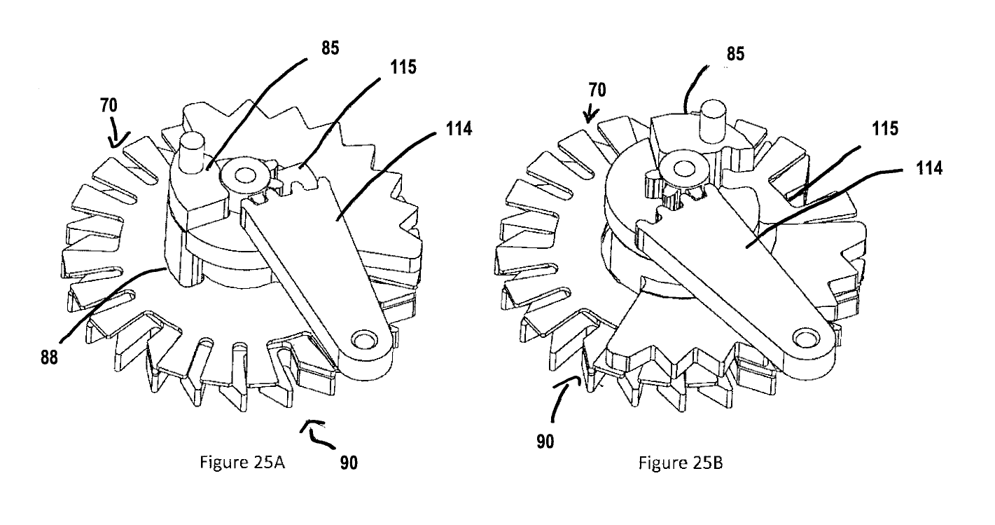

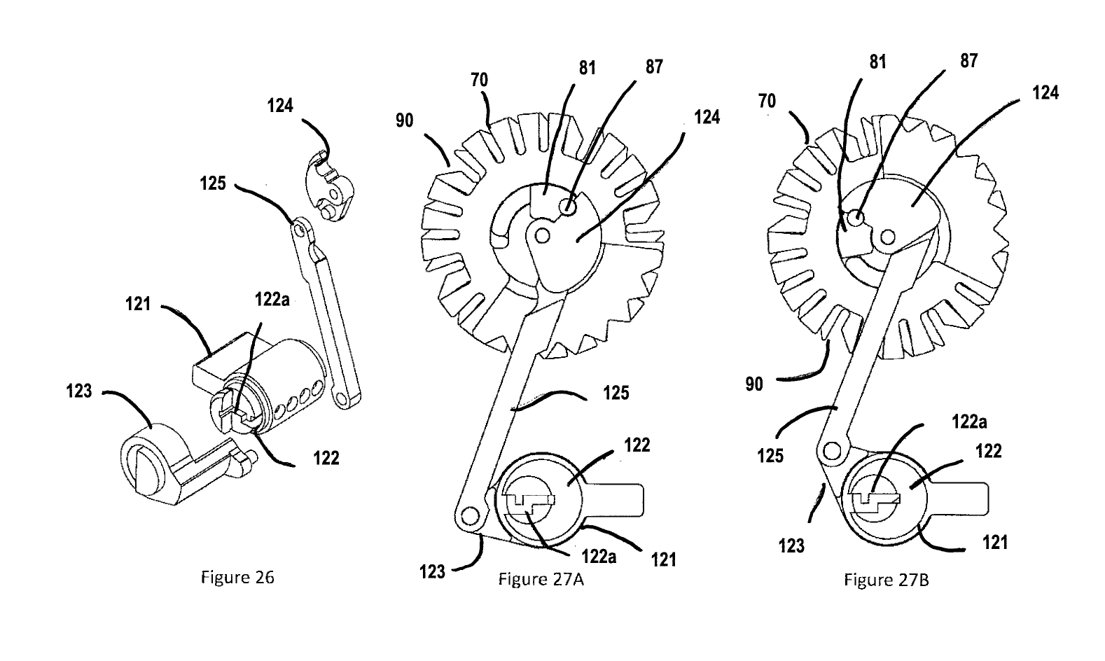

According to another aspect of the present application, the lock includes a mechanism for resetting the latch wheel 70 and counter wheel 90, for example, in the event that an incorrect combination code is entered, or to return the latching mechanism to the initial locked condition when the lock is re-locked (e.g., when the open padlock shackle is inserted through a hasp and returned to a closed or locked position). While many different arrangements may be utilized, in one embodiment, a reset mechanism may be operated by depressing the shackle both to disengage the detent member from the latch wheel 70 and the counter wheel 90, and to rotate the latch wheel and the counter wheel to the reset positions. In the illustrated embodiment, the reset mechanism 110 (FIGS. 21A and 21B) includes a plunger 111 (spring biased by spring 118) disposed beneath the short shackle leg 31, and pivotally connected to an actuating lever arm 112 to drive a detent releasing arm 113 against the detent spring 68 for release of the detent member 67 when the plunger 111 is depressed. The actuating lever arm 112 is further connected to a geared cam driving arm 114 for geared rotation of a geared cam 115 when the plunger is depressed. In other embodiments, the cam driving arm may drive the cam using a simple pivoting linkage. The rotating cam 115 engages the counter wheel rail 97 (FIG. 25A) of the counter wheel to rotate the counter wheel 90 in a first, resetting direction back to the reset, initial locked orientation (FIG. 23C). Engagement of counter wheel rail 97 with the latch wheel track 77 in turn rotates the latch wheel 70 back to the reset position. As shown in FIG. 22, the actuating lever arm 112 may be connected to the cam driving arm 114 by a pin 116 in a dwell slot 117, thereby allowing for release of the detent member 67 prior to cam rotation of the latch wheel 70 (FIG. 23B) when the plunger 111 is partially depressed.

According to another aspect of the present application, the lock may be provided with an override mechanism to permit authorized opening of the lock when the combination code is forgotten or not known (e.g., by an administrator). While many different arrangements may be utilized, in one embodiment, an override mechanism 120 (FIG. 26) includes a key cylinder 121 assembled with the lock body 20, with a cylinder plug 122 having a key slot 122a accessible through an opening in the back plate 28. The cylinder plug 122 is rotationally connected with a cylinder sleeve 123, which is connected with an override actuator 124 by a pivoting actuator arm 125. When the cylinder plug 122 is rotated from a locked position (FIG. 27A) to an unlocked or override position (FIG. 27B), the cylinder sleeve 123 pivots the actuator arm 125, which rotates the override actuator 124 to engage a latch wheel projection 87 (e.g., a projection on the detent wheel member 81, as shown) for rotation of the latch wheel 70 in a second, unlocking direction (opposite the resetting direction) into the unlocked orientation. An end surface of the arcuate track 77 engages the arcuate rail 97 of the counter wheel 90 to rotate the counter wheel into the unlocked orientation. While the override mechanism 120 may include an arrangement for disengaging the detent member 67, in the illustrated embodiment, the amount of torque provided by the key actuation is sufficient to drive the detent member 67 out of engagement with the latch wheel 70 and the counter wheel 90.

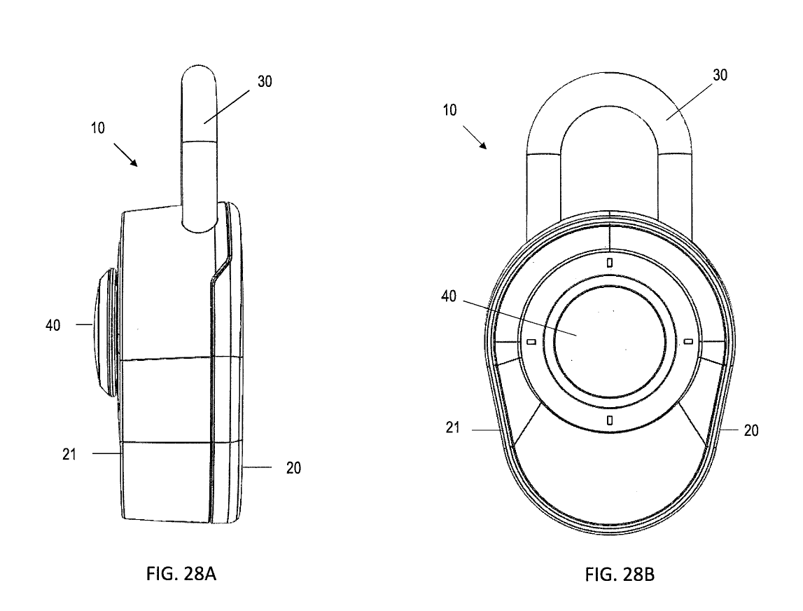

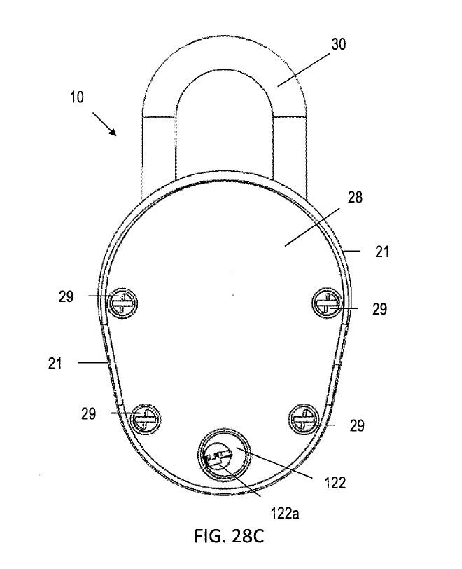

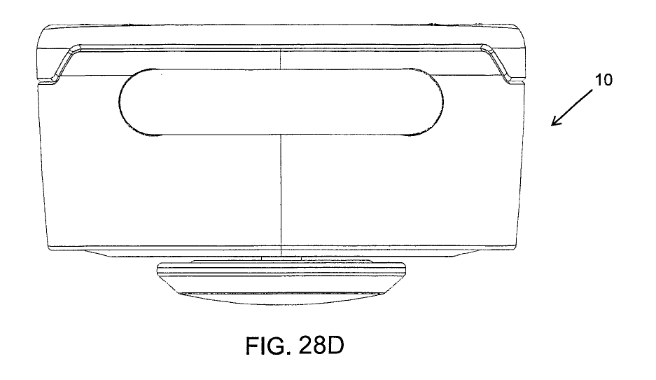

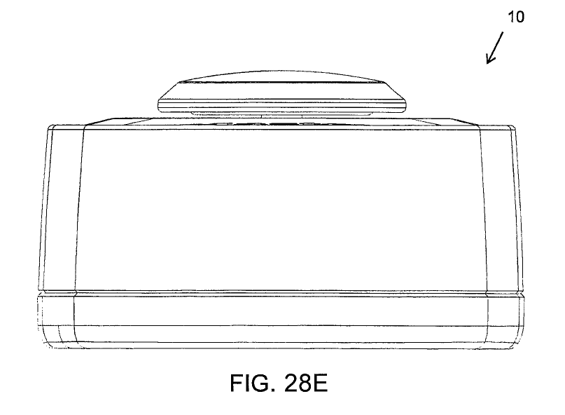

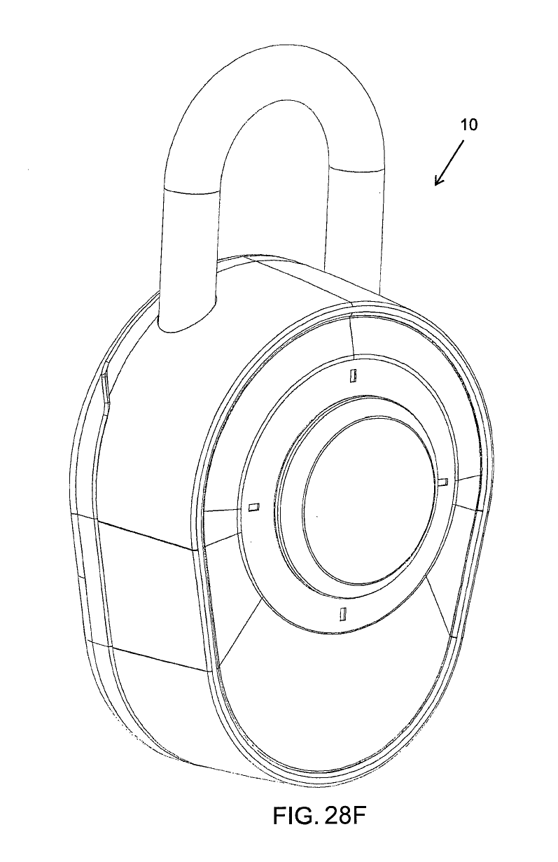

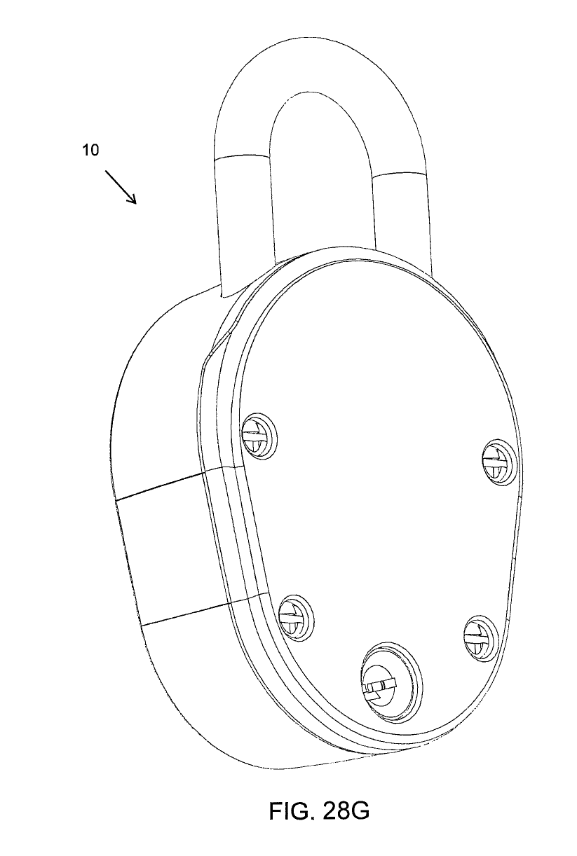

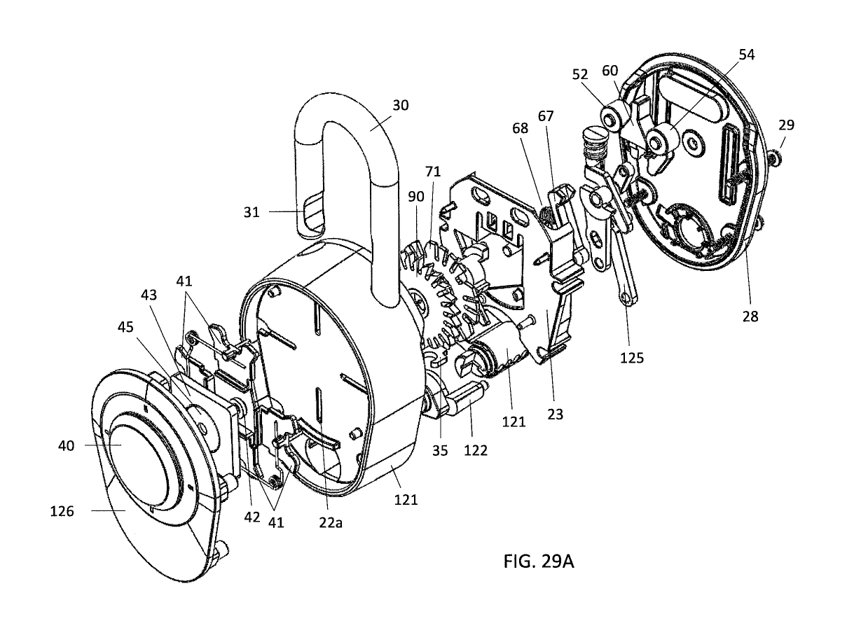

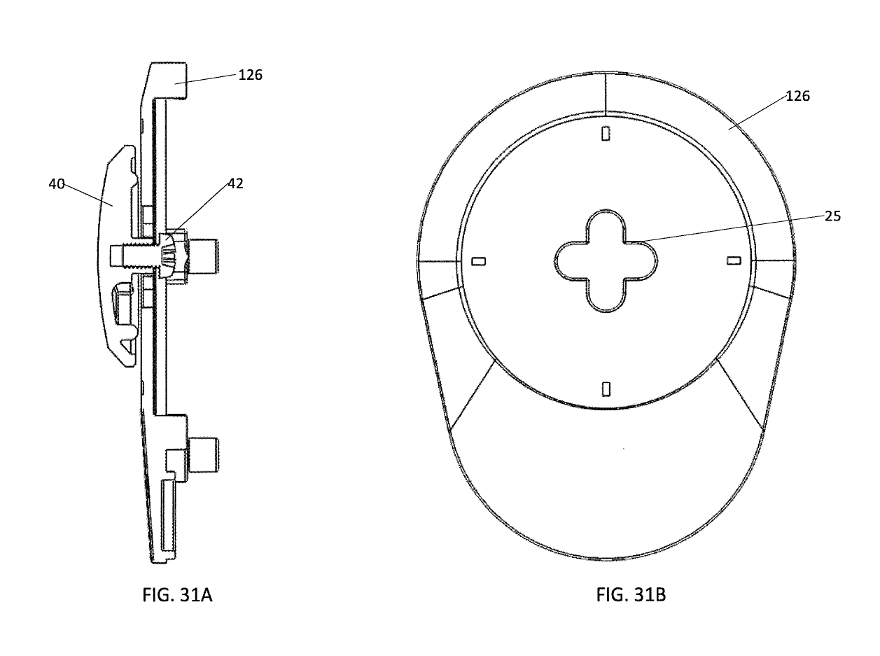

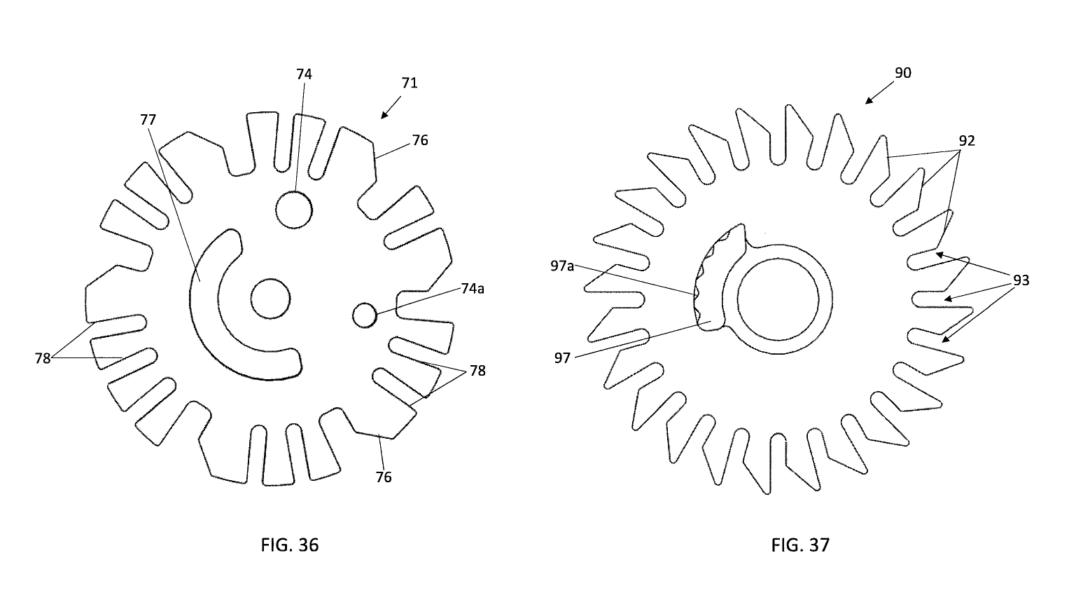

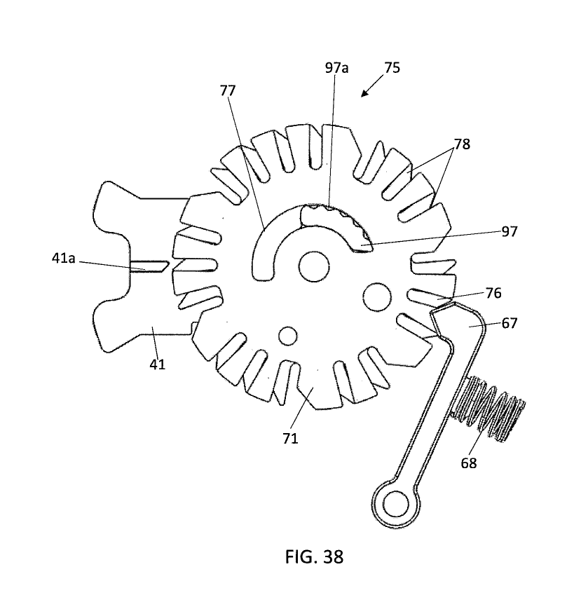

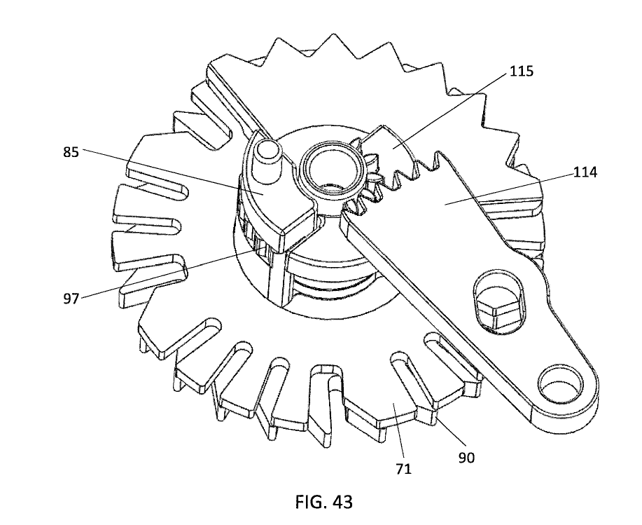

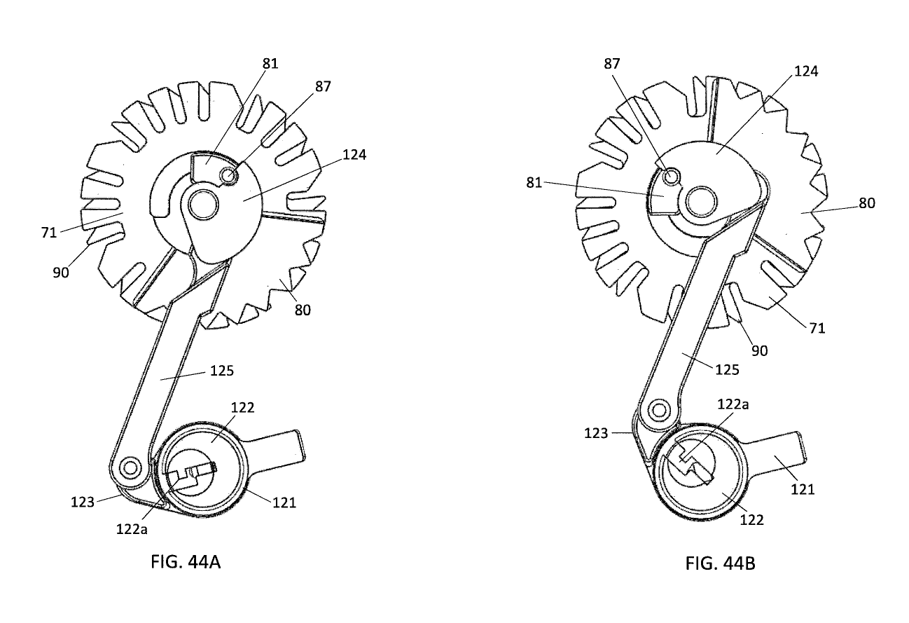

Many other exemplary padlock arrangements may be used to provide the locking, code entry, and code reset features described herein. FIGS. 28A-44B illustrate an exemplary padlock 10′ similar to the padlock 10 of FIGS. 2A-27B in structure and function (as shown by corresponding reference numbers), but with a number of varied features, any one or more of which may be incorporated into a lock in accordance with the present application.

For example, the padlock body may include a lock body housing 21′ adapted to include the features of the front insert 22 of the padlock 10 of FIGS. 2A-27B, a back plate 28′ adapted to include the features of the rear insert 24 of the padlock 10 of FIGS. 2A-27B, allowing for elimination of these front and rear insert components, and a front plate 126′, secured to the lock body 20′ by the fasteners 29′ installed through the back plate 28′. The front plate 126′ defines the front face of the lock, and defines the guide slot 25′ through which the button fastener 42′ extends (instead of the housing 21, as provided in the embodiment of FIGS. 2A-27B). In this arrangement, the button actuation features of the lock (e.g., the actuating frame 43′, actuator members 41′, and spring members 44′) are disposed between the front plate 126′ and the housing wall 22′ defining the actuator guide slots 22a′. The latching mechanism (e.g., the code wheel 71′, detent wheel member 81′, and counter wheel 90′) are disposed between the housing wall 22′ and the middle insert 23′, and the locking mechanism (e.g., the blocker 60′, the locking members 52′, 54′, and springs 55′) and the reset mechanism 110′ are disposed between the middle insert 23′ and the back plate 28′.

As another example, as evident in FIG. 29A, the locking members of the padlock 10′ of FIGS. 28A-44B may comprise rollers 52′, 54′ (instead of locking balls) having protrusions that are received in openings in the middle insert 23′ to position and guide the rollers for movement between the locked and unlocked positions.

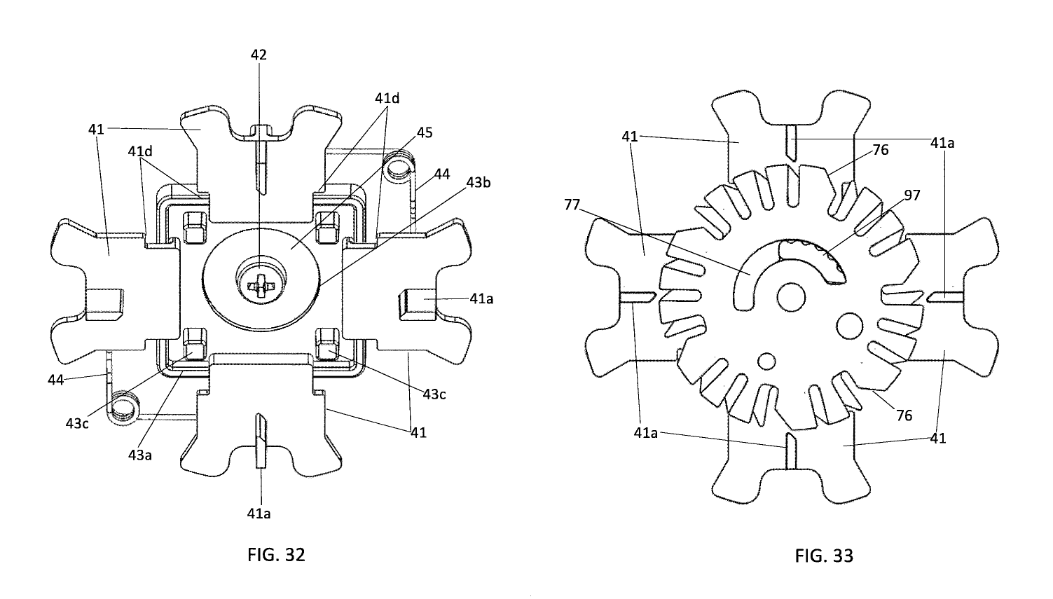

As another example, as shown in FIG. 32, the actuator frame 43′ may include rear posts 43c′ that restrict perpendicular movement of the actuator frame (i.e., preventing up/down movement when the button is moved left or right, or left/right movement when the button is moved up or down) during actuation, for example, by applying tension to the shackle in an effort to improperly manipulate the locking mechanism. The posts 43c′ closely align with corresponding notched shoulder portions 41d′ of the actuator members 41′ when the button 40′ and actuator frame 43′ are in an actuated position to block perpendicular movement.

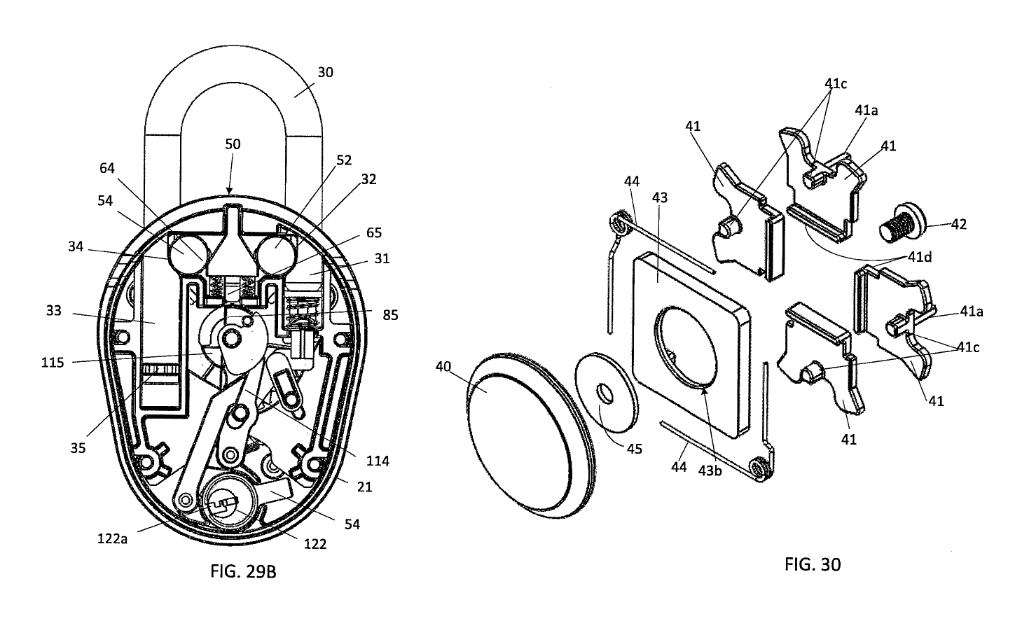

As another example, as shown in FIG. 30, the actuator frame 43′ may include an enlarged central opening 43b′ receiving the washer 45′, such that the actuator frame is actuated by the washer, secured to the button 40′ by the fastener 42′.

As another example, similar to the embodiment of FIG. 20 described above, the code wheel member 71′ may include the code portion teeth 76′, the arcuate track 77′, and the alignment slots 78′, thereby eliminating the alignment wheel member of the embodiment of FIGS. 2A-27B.

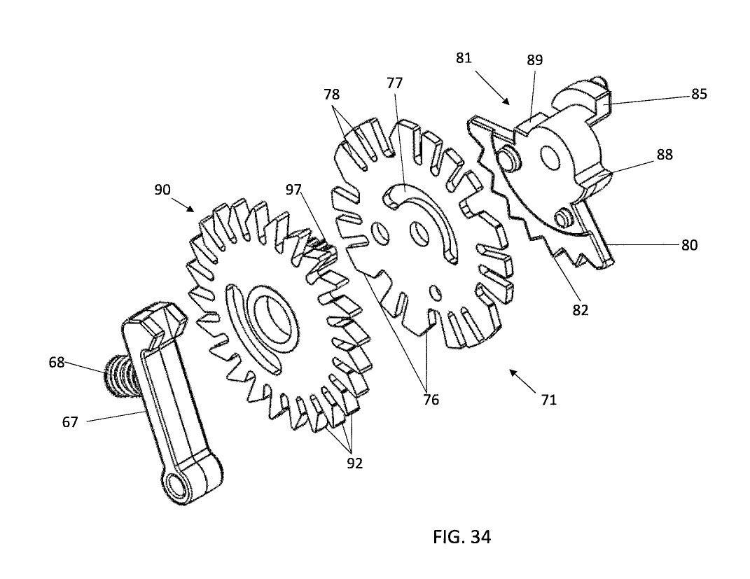

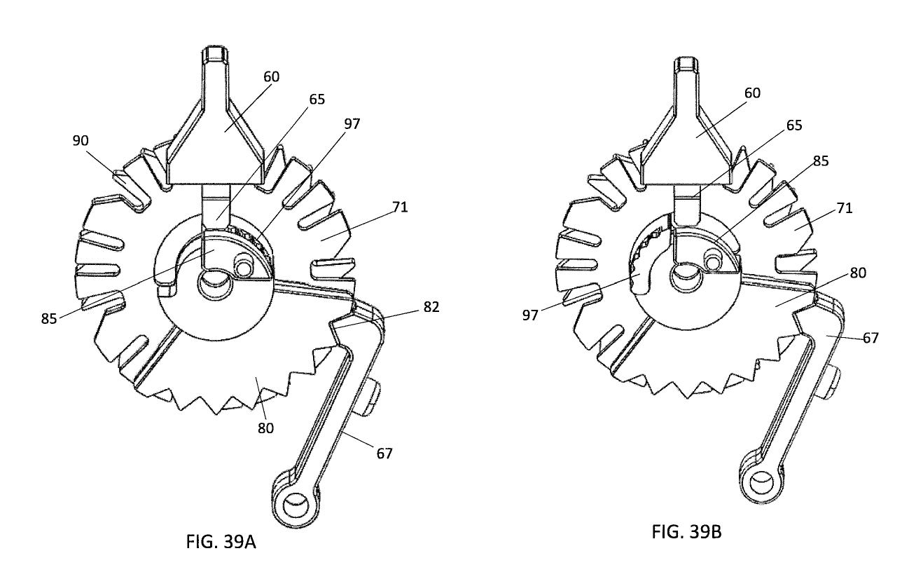

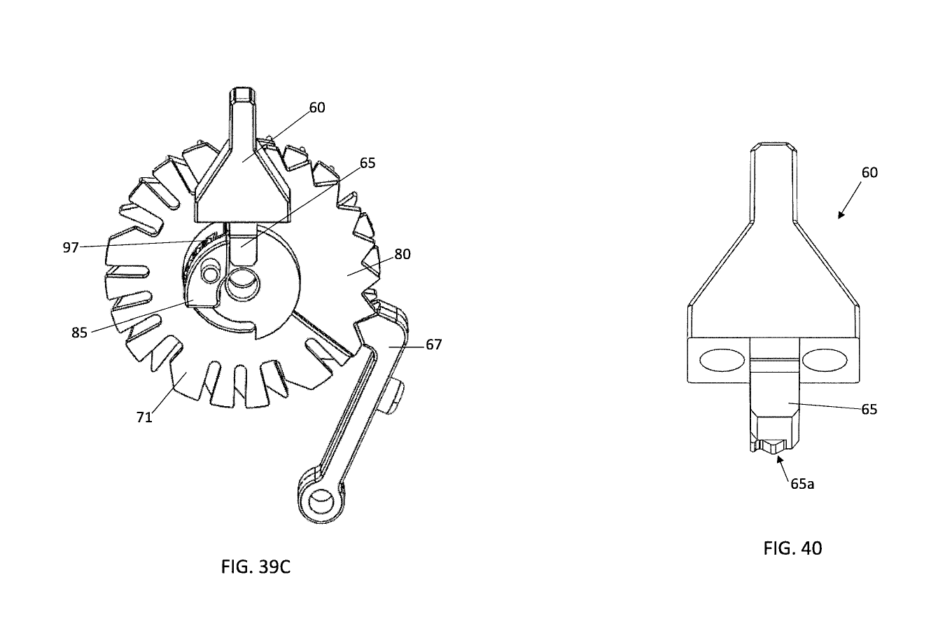

As another example, control of the incremental rotation of the code wheel 71′ and counter wheel 90′ of a padlock 10′ may be facilitated by a pivotable detent lever 67′ (FIGS. 34 and 39A-C) that is spring-biased by a compression spring 68′ (instead of the leaf spring biased sliding detent member 67 of the embodiment of FIGS. 2A-27B).

As another example, a detent wheel member 80′ and code wheel 71′ may be provided with a second alignment post 89a′ received in a second hole 74a′ in the code wheel 71′ to facilitate proper alignment and orientation of the detent wheel member with the code wheel.

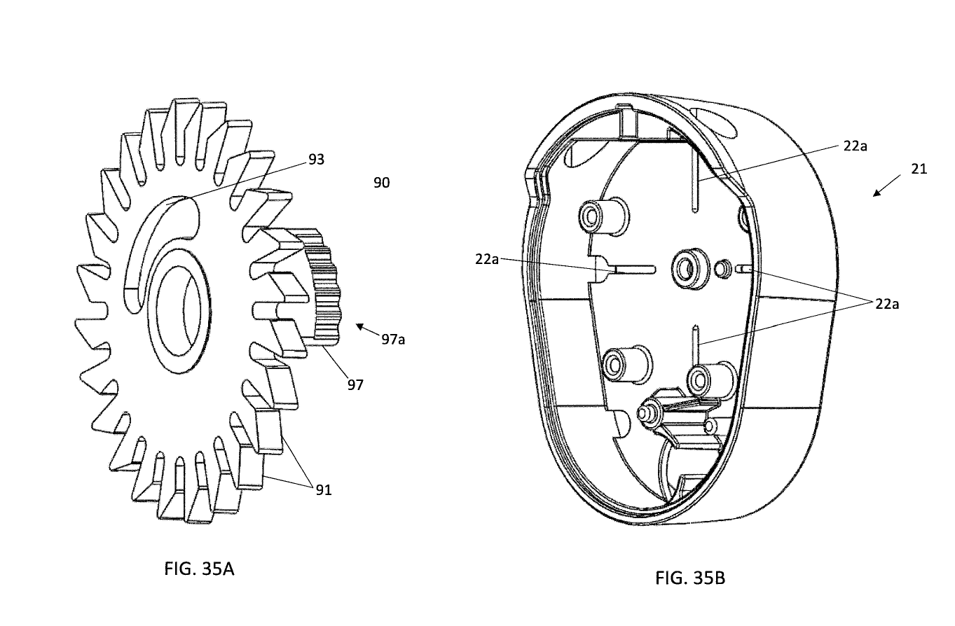

As another example, a blocking portion 97′ of a counter wheel 90′ may be provided with a ribbed, toothed or other such interlocking surface 97a′ (FIG. 35A) that engages a corresponding interlocking end portion 65a′ of the blocker post 65′ (FIG. 40). In addition to securing the counter wheel 90′ against rotation when the shackle is under tension, the interlocking end portion of the blocker post biases the counter wheel forward slightly (i.e., counterclockwise as viewed in FIG. 39A) to align the ramped portions of the gear teeth 92′ with the actuating portions 41a′ of the actuator members 41′ (and misaligning the notches 91′ from the actuating portions 41a′) to ensure that the counter wheel 90′ advances with the code wheel 71′ when tension is applied to the shackle 30′.

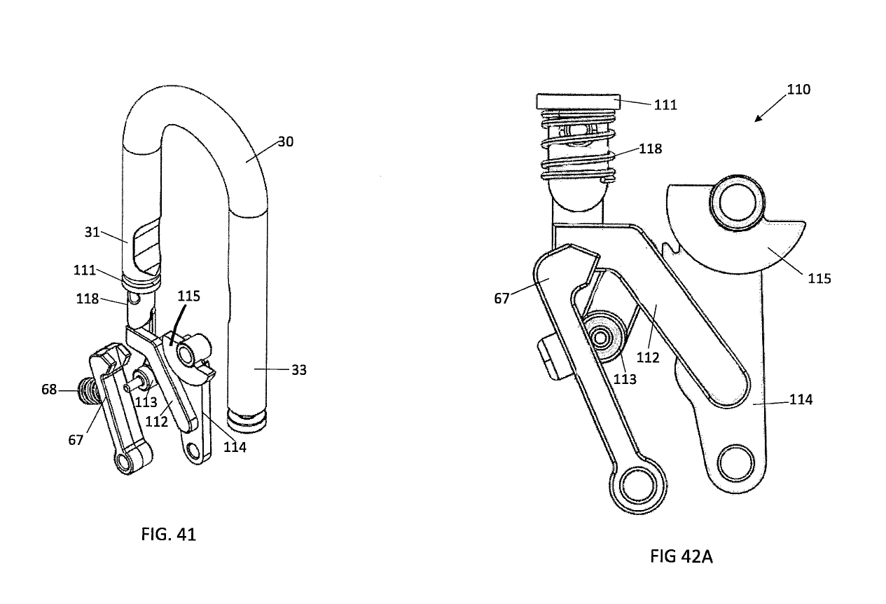

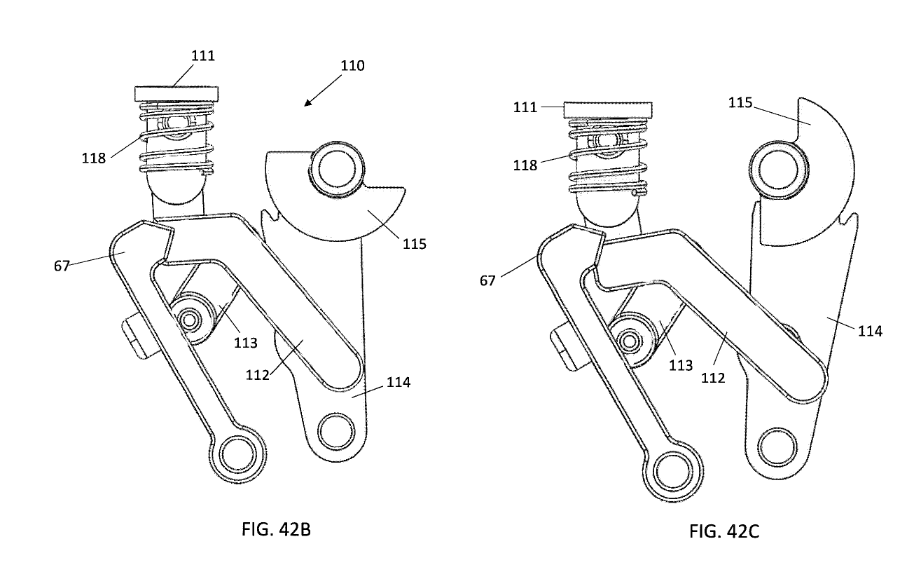

As another example, the reset mechanism may include a detent releasing arm 113′ that directly engages the detent member 67′ (FIGS. 41-42C), instead of engaging the biasing spring as with the embodiment of FIGS. 2A-27B.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lock comprising:
a lock body,
a locking element secured with the lock body and movable between a locked position and an unlocked position;
a latch disposed within the lock body and movable between an initial locked position, in which the latch blocks movement of the locking element from the locked position to the unlocked position, and an unlocked position, in which the latch permits movement of the locking element from the locked position to the unlocked position;
a user manipulable lock interface carried by the lock body, and selectively operable to a plurality of code entry conditions;
an actuator mechanism disposed within the lock body and operable by user manipulation of the lock interface to any one of the plurality of code entry conditions, wherein when the lock interface is operated to a correct one of the plurality of code entry conditions, the actuator mechanism engages the latch and incrementally advances the latch toward the unlocked position, such that when the lock interface is operated to a sequence of N correct code entry conditions, the latch is moved from the initial locked position to the unlocked position; and
a counter member disposed within the lock body and movable between a start position and a stop position in which the counter member prevents further operation of the actuator mechanism, wherein when the lock interface is operated to any one of the plurality of code entry conditions, the actuator mechanism engages the counter member and incrementally advances the counter member toward the stop position, such that when the lock interface is operated to a sequence of N code entry conditions in which at least one of the sequence of N code entry conditions is an incorrect code entry condition, the counter member is moved from the start position to the stop position before the latch can be advanced to the unlocked position.

2. The lock of claim 1, wherein the latch comprises a latch wheel incrementally rotatable about a central wheel axis between the initial locked position and the unlocked position.

3. The lock of claim 2, wherein the latch wheel includes a toothed surface engageable by the actuator mechanism to incrementally rotate the latch wheel when the lock interface is operated to a correct one of the plurality of code entry conditions.

4. The lock of claim 1, wherein the counter member comprises a counter wheel incrementally rotatable about a central wheel axis between the start position and the stop position.

5. The lock of claim 4, wherein the counter wheel includes a toothed surface engageable by the actuator mechanism to incrementally rotate the counter wheel when the lock interface is operated to any one of the plurality of code entry conditions.

6. The lock of claim 1, wherein the locking element comprises a shackle that is secured in a closed condition when the latch is in the locked position, the shackle being movable to an open position when the latch is in the unlocked position.

7. The lock of claim 1, wherein the lock interface comprises a button disposed on an exterior surface of the lock body, the button being slideable to a plurality of directional positions corresponding with the plurality of code entry conditions.

8. The lock of claim 7, wherein the plurality of directional positions comprises first, second, third and fourth directional positions.

9. The lock of claim 7, further comprising at least one spring member configured to bias the button to a non-actuated position from any of the plurality of directional positions.

10. The lock of claim 1, wherein the actuator mechanism comprises a plurality of actuator members, wherein operation of the lock interface to any one of the plurality of code entry conditions causes a corresponding one of the plurality of actuator members to be moved into engagement with the latch and the counter member.

11. The lock of claim 1, further comprising a reset mechanism disposed in the lock body and operable to return the latch to the initial locked position and to return the counter member to the start position.

12. The lock of claim 11, wherein the locking element comprises a shackle that is secured in a closed condition when the locking element is in the locked position, the shackle being movable to an open position when the locking element is in the unlocked position, wherein the reset mechanism comprises a plunger disposed beneath a leg of the shackle, such that the reset mechanism is operated by depressing the closed shackle.

13. The lock of claim 1, further comprising a key override mechanism disposed in the lock body and including a key cylinder, the key override mechanism being operable to move the latch to the unlocked position when an authorized key in inserted in the key cylinder and rotated to an override position.

14. The lock of claim 1, further comprising a detent member that engages the counter member and the latch to bias the counter member and the latch into a selected incremental position.

15. The lock of claim 1, further comprising a blocker slidable between a locked condition securing the locking element in the locked position, and an unlocked condition permitting movement of the locking element to the unlocked position, wherein the latch prevents movement of the blocker to the unlocked condition when the latch is in the locked position.

16. The lock of claim 15, wherein the latch comprises a recess that aligns with the blocker when the latch is in the unlocked position, to permit movement of the blocker to the unlocked condition.

17. A padlock comprising:
a lock body,
a shackle secured with the lock body and movable between a closed position and an open position;
a blocker disposed within the lock body and movable between a locked condition securing the shackle in the closed position, and an unlocked condition permitting movement of the shackle to the open position.
a latch wheel disposed within the lock body and rotatable in N increments between an initial locked position, in which the latch blocks movement of the blocker from the locked condition to the unlocked condition, and an unlocked position, in which a recess in the latch wheel permits movement of the blocker from the locked condition to the unlocked condition;
a user manipulable lock interface carried by the lock body, and selectively operable to a plurality of code entry conditions;
an actuator mechanism disposed within the lock body and operable by user manipulation of the lock interface to any one of the plurality of code entry conditions, wherein when the lock interface is operated to a correct one of the plurality of code entry conditions, the actuator mechanism engages the latch wheel and incrementally advances the latch wheel toward the unlocked position, such that when the lock interface is operated to a sequence of N correct code entry conditions, the latch is moved from the initial locked position to the unlocked position; and
a counter wheel disposed within the lock body and rotatable in N increments between a start position and a stop position in which the counter wheel prevents further operation of the actuator mechanism, wherein when the lock interface is operated to any one of the plurality of code entry conditions, the actuator mechanism engages the counter wheel and incrementally advances the counter wheel toward the stop position, such that when the lock interface is operated to a sequence of N code entry conditions in which at least one of the sequence of N code entry conditions is an incorrect code entry condition, the counter member is moved from the start position to the stop position before the latch wheel can be advanced to the unlocked position.

18. A lock comprising:
a lock body,
a locking element secured with the lock body and movable between a locked position and an unlocked position;
a means for latching the locking element in the locked position;
a user manipulable lock interface carried by the lock body, and selectively operable to a plurality of code entry conditions;
a means for actuating the latching means to incrementally advance the latching means toward an unlocked position, such that when the lock interface is operated to a sequence of N correct code entry conditions, the latching means is moved from an initial locked position to the unlocked position; and
a means for preventing further operation of the actuating means when the lock interface is operated to the sequence of N code entry conditions, such that when at least one of the sequence of N code entry conditions is an incorrect code entry condition, further operation of the actuating means is prevented before the latching means can be advanced to the unlocked position.
